(19) United States
(12) Patent Application Publication
(10) Pub. No.: US 2019/0023036 A1
(43) Pub. Date: Jan. 24, 2019

(54) BAIL ARM TO APPLY FORCE

(71) Applicant: Hewlett-Packard Development Company, L.P., Houston, TX (US)

(72) Inventors: Emma Kelp-Stebbins, Vancouver, WA (US); Daniel Fredrickson, Portland, OR (US); Jason Carothers, Vancouver, WA (US); Kevin Lo, Vancouver, WA (US)

(21) Appl. No.: 16/067,299

(22) PCT Filed: Apr. 29, 2016
(86) PCT No.: PCT/US2016/030018

§ 371 Date: Jun. 29, 2018

(51) Int. Cl. B41J 13/20; B65H 31/02; B41J 11/04

(52) U.S. Cl. CPC B41J 13/20; B65H 31/02; B41J 11/04; B65H 2801/15; B65H 2402/31; B65H 2402/545; B65H 2301/421

(57) ABSTRACT

Examples disclosed herein relate to a device including a bail arm to apply force to an output bin. In examples, a force providing member coupled to the bail arm is to provide a counter force to reduce the force applied by the bail arm to the output bin.

### BACKGROUND

Sheet outputting devices—including printers, finisher, copiers, scanners, fax machines, multifunction printers, all-in-one devices, or other devices—process and output media such as plain paper, photo paper, transparencies, and other media. In some examples, sheet outputting devices can output media stacks of metals and polymeric media, such as Compact Discs, in addition to or instead of broad and thin media. Sheet outputting devices may output multiple sheets of media into an output tray.

### BRIEF DESCRIPTION OF THE DRAWINGS

The following detailed description references the drawings, wherein:

FIG. 1 is a partial schematic view of a device according to an example.

FIG. 2 is a partial schematic view of the device of FIG. 1 according to an example.

FIG. 3 is a partial side schematic view of the device of FIG. 1 depicting an output tray assembly according to an example,

FIG. 4 is a partial schematic rear view of an output tray assembly according to an example.

### DETAILED DESCRIPTION

In the following discussion and in the claims, the term “couple” or “couples” is intended to include suitable indirect and/or direct connections. Thus, if a first component is described as being coupled to a second component, that coupling may, for example, be: (1) through a direct electrical or mechanical connection, (2) through an indirect electrical or mechanical connection via other devices and connections, (3) through an optical electrical connection, (4) through a wireless electrical connection, and/or (5) another suitable coupling. The term “connect” or “connected” is intended to include suitable direct connections.

A number of devices output sheets of media into an output bin or tray for retrieval. The size of output media may vary. The speed at which electronic devices process media has been increasing. For example, printing speeds and scanning speeds of devices are increasing. As a result, media is being output to the output tray at increasing rates. Bail arms have been used to control media from ejecting off the output tray. In an example, a number of different print jobs or scan jobs with different size media may be output by an electronic device to an output tray within a short period of time. However, a user may not retrieve the output media immediately. As a result, bail arms may be used to control large volumes of different sized media on an output tray. The dimensions of a bail arm may be chosen to control the smallest sized media output by a device. However, such bail arms may not allow larger sized media to slide underneath or on top of a media stack on the output tray.

To address these issues, in the examples described herein, a device is described which includes a bail arm to control output media. The device includes a force providing member to provide a counter force to the force of gravity on the bail arm such that a force applied by the bail arm on an output tray is less than the force of gravity on the bail arm. In such an example, the dimensions of the bail arm may be optimized to control different sized media while allowing the bail arm to supply sufficient force to retain a media stack in the output tray.

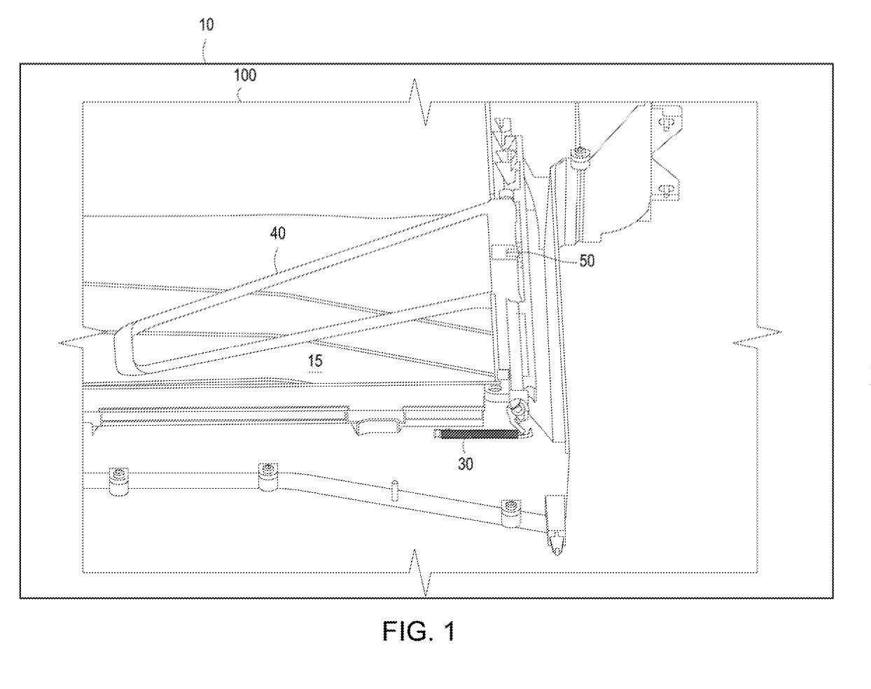

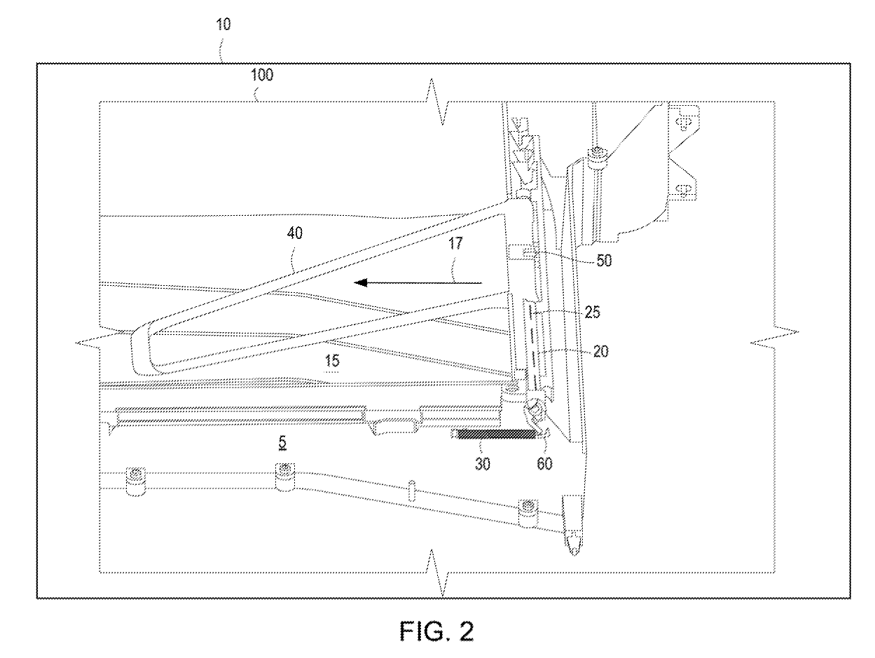

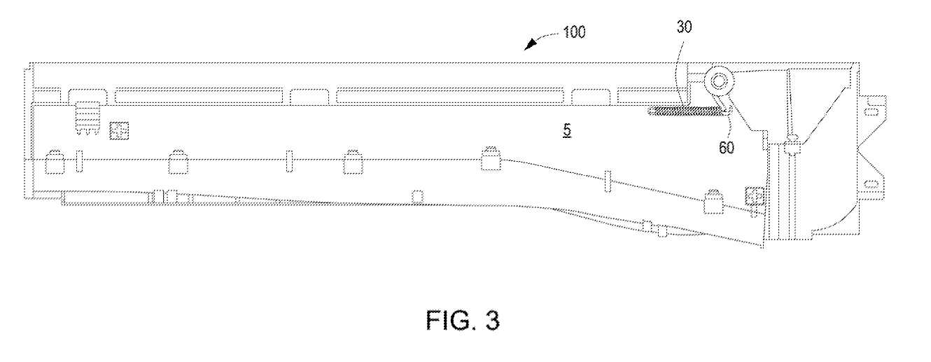

Referring now to the drawings, FIG. 1 is a partial schematic view of a device 10 according to an example. FIG. 2 is a partial schematic view of device 10 of FIG. 1 according to an example. FIG. 3 is a partial side schematic view of device 10 of FIG. 1 depicting an output tray assembly 100 according to an example, In examples, device 10 includes an output tray 15, an axle 20, a force providing member 30, a bail arm 40, a pin 50, and an arm 60. In examples, bail arm 40 is coupled to device 10 above output tray 15 to provide a downward force on output tray 15. In examples, force providing member 30 is coupled to bail arm 40 to provide a counter force to the downward force applied by bail arm 40 on output tray 15.

In examples, device 10 may be any device to output media which may be stacked on an output tray, such as an imaging device, a finisher, etc. An “imaging device” may be a hardware device, such as a printer, multifunction printer (MFP), or any other device with functionalities to physically produce graphical representation(s) (e.g., text, images, models etc.) on paper, photopolymers, thermopolymers, plastics, fabric, composite, metal, wood, or the like. In some examples, an MFP may be capable of performing a combination of multiple different functionalities such as, for example, printing, photocopying, scanning, faxing, etc. In examples, media may be any type of paper, photopolymers, thermopolymers, plastics, fabric, composite, metal, wood, etc., which may be stacked in an output tray 15 of device 10. In examples, device 10 may output media along media path 17. In examples, media path 17 may be an output media path or a media ejection path for media ejected by device 10. In an example, device 10 may be an inkjet printer to eject paper along media path 17 onto output tray 15. In other examples, device 10 may a laser printer to output media onto output tray 15.

In examples, output tray 15 may be any structure to receive media output from device 10. In some examples, output tray 15 may be integrated into device 10. In other examples, output tray 15 may be a separate device coupled to device 10. In examples, output tray 15 may include a surface to receive multiple sheets or a stack of output media from device 10. Various parameters related to output tray 15 may be selected for the particular use and design of device 10. For example, the dimensions and orientation of output tray 15 may be determined by the size of the device 10 and the particular use of the system.

In examples, axle 20 may be coupled to device 10 above the receiving surface of output tray 15. Axle 20 includes a central axis 25. Axle 20 may be any type of shaft about which an object may rotate. In some examples, axle 20 may be composed of any material to allow axle 20 to securely couple to and retain bail arm 40 on device 10 such as metal, plastic, composite, wood, etc.

In some examples, force providing member 30 may be any type of force providing member to apply a force. In examples, force providing member 30 may provide a force opposite to a rotational force of bail arm 40 about central axis 25. In examples, force providing member 30 may be a spring, such as a coiled torsion spring. In examples, the force applied by force providing member 30 may be transferred to bail arm 40 via axle 20.

In some examples, bail arm 40 may be any component with a surface area to apply a downward force on output tray 15. In examples, bail arm 40 may be configured to engage or contact a medium as it travels along media path 17 onto output tray 15. In examples, bail arm 40 may be configured to apply a downward force to a medium in output tray 15. In some examples, bail arm 40 may apply sufficient force to medium traveling along media path 17 to retain the medium in output tray 15. In an example, bail arm 40 may be configured to apply sufficient force to retain paper being ejected by an inkjet printer into an output tray that includes a number of printed pages stacked thereon. in examples, bail arm 40 may be composed of any material with sufficient structural integrity to apply the downward force on output tray 15. For example, bail arm 40 may be composed of a metal, such as aluminum, a metal composite, such as steel, a plastic, a wood, a composite, such as carbon fiber, carbon reinforced plastics, glass-filled plastic, glass-filled nylon, glass-filled polycarbonate, glass filled acrylonitrile butadiene styrene (ABS), etc. Various parameters related to bail arm 40 may be selected for the particular use and design of device 10. For example, the dimensions and orientation of bail arm 40 may be determined by the size of the device 10, the size and orientation of media stacked on output tray 15, the ejection rate of media onto output tray 15, and the particular use of the system. In an example, the dimensions of bail arm 40 may be chosen to allow variability in the dimensions of output media. For example, bail arm 40 may be dimensioned o con act different sized media, such as, A3 media or A4 media.

In some examples, bail arm 40 may be coupled to axle 20 in any manner to rotate about central axis 25. In such examples, bail arm 40 may freely rotate about central axis 25 until it comes in contact with another component, for example, output tray 15 disposed below axle 20. In examples, a bail arm 40 may rotate about central axis 25 in response to the force of gravity on bail arm 40. In examples, force providing member 30 may provide a counter force to the force of gravity on the bail arm to reduce the force bail arm 40 applies to output tray 15. In the example, the counter force supplied by force providing member 30 may be transferred to bail arm 40 via axle 20.

In the example of FIGS. 1-3, axle 20 may be coupled to force providing member 30 via an am 60. In such an example, force providing member 30 may be disposed along a sidewall 5 of output tray assembly 100. In such an example, arm 60 may be dimensioned to couple force providing member 30 and axle 20. In other examples, one or more intermediate components may be disposed to couple force providing member 30 and axle 20. In examples, a pin 50 may connect axle 20 to bail arm 40. In such examples, pin 50 may transfer the counter force from force providing member 30 to the bail arm 40.

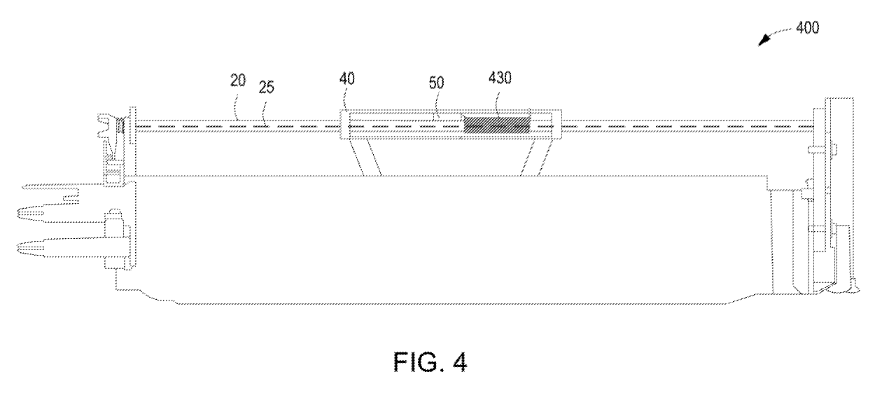

FIG. 4 is a partial schematic rear view of output tray assembly 400 according to an example. In the example of FIG. 4, similarly numbered elements are substantially similar to elements of FIGS. 1-3. In the example of FIG. 4, a force providing member 430 may be disposed to engage axle 20. In an example, force providing member 430 may be coupled to bail arm 40 at a first end to provide a counter force to the force of gravity on bail arm 40. For example, force providing member 30 may be connected to pin 50 at a first end to provide a counter force to the force of gravity on bail arm 40. In other examples, force providing member 430 may be connected to bail arm 40 directly at the first end. In examples, a second end of force providing member 30 may be connected to a frame (not shown) of output tray assembly 400.

In examples, in operation, bail arm 40 may rotate about axle 20 such that bail arm 40 provides a downward force to a media stack ejected onto output tray 15. Force providing member 30 provides a counter force to the force of gravity on bail arm 40 to reduce the weight of bail arm 40 on the media stack. In such examples, bail arm 40 may be able to control different sized media being ejected onto output tray 15 at the same time. In examples, the dimensions of bail arm 40 may be optimized to control different sized media while maintaining the same effective weight of bail arm 40 on output tray 15 by use of force providing member 30.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be understood that the systems, apparatuses, and methods described herein can include various combinations and/or sub-combinations of the components and/or features of the different implementations described. Thus, features described with reference to one or more implementations can be combined with other implementations described herein.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A device, comprising:
a bail arm to apply a force to an output bin; and
a force providing member coupled to the bail arm to provided counter force to reduce the force applied by the bail arm to the output bin.

2. The device of claim 1, further comprising an axle coupled to the bail arm, about which the bail arm may rotate, to transfer the counter force from the force providing member to the bail arm.

3. The device of claim 2, further comprising a pin to couple the axle to the bail arm an to transfer the counter force to the bail arm.

4. The device of claim 1, further comprising an arm coupled to the force providing member.

5. The device of claim 1, wherein the force providing member is connected to the bail arm.

6. The device of claim 1, wherein the force providing member is connected to a pin coupled to the bail arm.

7. The device of claim 1 wherein the counter force applied by the force providing member is less than a force of gravity applied to the bail arm.

8. The device of claim 1, wherein the bail arm is comprised of at least one of a carbon reinforced plastics, a glass-filled plastic, a glass-filled nylon, a glass-filled polycarbonate, a glass filled acrylonitrile butadiene styrene (ABS), a metal, a metal composite, a plastic, and a wood.

9. The device of claim 1, wherein the force providing member is a coiled torsion spring.

10. An output tray assembly, comprising:
a bail arm to apply a force to a surface;
an axle coupled to the bail arm; and
a spring coupled to the axle to provide a counter force to reduce the force applied by the bail arm to the surface.

11. The output tray assembly of claim 10, further comprising a pin to transfer the counter force from the spring to the bail arm.

11. The output tray assembly of claim 10, further comprising an arm coupled to the spring and the axle.

12. The output tray assembly of claim 10, wherein the spring is connected to the bail arm.

13. The output tray assembly of claim 12, wherein the spring is connected to a frame of the output tray assembly.

14. An imaging device, comprising:
a bail arm to apply a force to an output tray;
an axle coupled to the bail arm;
a coiled torsion spring coupled to the axle to provide a counter force to reduce the force applied by the bail arm to the output tray; and
a pin to transfer the counter force from the spring to the bail arm,
wherein a counter force is less than a force of gravity applied to the bail arm.

15. The imaging device of claim 14, further comprising an arm coupled to the spring and the axle.
